(19) United States
(12) Patent Application Publication
(10) Pub. No.: US 2025/0208009 A1
(43) Pub. Date: Jun. 26, 2025

(54) Methods, Systems, and Devices for Slide Preparation

(71) Applicant: IDEXX Laboratories, Inc., Westbrook, ME (US)

(72) Inventors: Jeremy Hammond, Westbrook, ME (US); Keith Nassif, Westbrook, ME (US)

(21) Appl. No.: 18/989,378

(22) Filed: Dec. 20, 2024

Related U.S. Application Data
(60) Provisional application No. 63/613,413, filed on Dec. 21, 2023.

(51) Int. Cl. G01N 1/30; G01N 1/31

(52) U.S. Cl. CPC G01N 1/30; G01N 1/31

(57) ABSTRACT

An example slide preparation device is disclosed, which includes (i) a vertical mounting member; (ii) an upper coupling member engaged with the vertical mounting member, wherein the upper coupling member comprises a depression member structurally configured to engage a syringe assembly plunger; (iii) a lower coupling member engaged with the vertical mounting member, wherein the lower coupling member is structurally configured to receive a sample syringe assembly comprising a biological fluid sample and the syringe assembly plunger; (iv) a horizontal mounting member, wherein the horizontal mounting member interfaces with the vertical mounting member; and (v) a depression structure engaged with the vertical mounting member and the horizontal mounting member, wherein the depression structure comprises a slide holder, and wherein the depression structure interfaces with the depression member to depress the syringe assembly plunger and deposits the biological fluid sample on a portion of a slide in the slide holder.

### CROSS-FERENCE TO RELATED APPLICATIONS

This application claims the benefit of co-pending U.S. Provisional Patent Application Ser. No. 63/613,413, filed Dec. 21, 2023, which is hereby incorporated by reference its entirety.

### FILED OF THE DISCLOSURE

The present disclosure involves devices and systems for preparing a biological sample, and methods for using the devices and systems thereof. Namely, devices, systems, and methods of the present disclosure involve a slide preparation device for depositing a biological fluid sample on a slide for testing and/or further analysis.

### BACKGROUND

Sample preparation and analysis can be conducted utilizing a variety of different methods, including dry samples and wet samples.

### SUMMARY

Historically, biological samples have been examined under a microscope by preparing a dry sample of the biological sample prior to viewing and/or otherwise analyzing the dried sample underneath a microscope. These dry samples are typically manually prepared by a technician using a smear technique on a glass slide. To increase the accuracy of assay test results, it is desirable to, prior to analysis, ensure that the sample is not altered (e.g., via physical interaction with a technician).

When technicians manually prepare the dry sample for testing, a technician typically places a fluid sample on a slide, then manually spreads the sample across the slide (often referred to as “smearing” the sample) and allows the sample to dry prior to analysis under the microscope. After a fluid sample has been prepared and has dried, a technician may also apply a stain and/or one or more additional fluids to the sample. In doing so, the composition, consistency, physical attributes, homogeneity, and other characteristics of the components of the sample throughout the prepared dried sample will be impacted by the process. As a result, it may be difficult for some technicians to find appropriate cells in different areas of the slide and understand what features are artifacts of the process and how to interpret them. Further, because the process of preparing the dried sample is performed by a variety of different technicians in different clinical settings, the variability of the prepared dried samples is substantial, which in turn can also impact the accuracy and precision of any analytical results for which the dried sample may be used. Accordingly, manual preparations of the samples are subject to variability between preparations and/or operators and, thus, degrade the accuracy and precision of any associated analytical results.

In an example, a slide preparation device is disclosed. The slide preparation device includes (i) a vertical mounting member; (ii) an upper coupling member engaged with the vertical mounting member, wherein the upper coupling member comprises a depression member structurally configured to engage a syringe assembly plunger; (iii) a lower coupling member engaged with the vertical mounting member, wherein the lower coupling member is structurally configured to receive a sample syringe assembly comprising a biological fluid sample and the syringe assembly plunger; (iv) a horizontal mounting member, wherein the horizontal mounting member interfaces with the vertical mounting member; and (v) a depression structure engaged with the vertical mounting member and the horizontal mounting member, wherein the depression structure comprises a slide holder, and wherein the depression structure interfaces with the depression member to depress the syringe assembly plunger and deposits the biological fluid sample on a portion of a slide in the slide holder when the depression structure is moved in a direction defined by at least one of the vertical mounting member and the horizontal mounting member.

In another example, a method for preparing a slide is disclosed. The method includes receiving a syringe assembly in a slide preparation device, wherein the syringe assembly comprises a needle, a plunger, and a chamber comprising biological fluid sample, and wherein the slide preparation device comprises a lower coupling member that holds the syringe assembly at a configurable angle with respect to the slide positioned on a slide holder of the slide preparation device. The method additionally includes depressing the plunger of the syringe via a depression structure of the slide preparation device, wherein the depression structure interfaces with a depression member of an upper coupling member of the slide preparation device to depress the plunger and deposit the biological fluid sample on a portion of the slide when the depression structure is moved in a direction defined by at least one of a vertical mounting member and a horizontal mounting member of the slide preparation device.

In another example, a non-transitory computer-readable medium comprising instructions that, when executed, cause one or more processors to perform a set of operations is disclosed. In examples, the set of operations includes receiving a syringe assembly in a slide preparation device, wherein the syringe assembly comprises a needle, a plunger, and a chamber comprising biological fluid sample, and wherein the slide preparation device comprises a lower coupling member that holds the syringe assembly at a configurable angle with respect to a slide positioned on a slide holder of the slide preparation device. In examples, the set of operations additionally includes depressing the plunger of the syringe via a depression structure of the slide preparation device, wherein the depression structure interfaces with a depression member of an upper coupling member of the slide preparation device to depress the plunger and deposit the biological fluid sample on a portion of a slide in the slide holder by moving the depression structure in a direction defined by at least one of a vertical mounting member and a horizontal mounting member of the slide preparation device.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2A illustrates an example slide preparation device from a front view, according to an example embodiment.

FIG. 2B illustrates the example slide preparation device of FIG. 2A from a side view, according to an example embodiment.

FIG. 2C illustrates the example slide preparation device of FIGS. 2A-2B from an isometric view, according to an example embodiment.

FIG. 3A illustrates an example slide preparation device from a front view, according to an example embodiment.

FIG. 3B illustrates the example slide preparation device of FIG. 3A from a side view, according to an example embodiment.

FIG. 3C illustrates the example slide preparation device of FIGS. 3A-3B from an isometric view, according to an example embodiment

FIG. 4 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the present disclosure is directed to devices and systems for preparing a slide with a biological fluid sample, and methods for using the devices and systems thereof.

Testing and/or imaging, as referred to herein, may include, for example, capturing one or more images related to a sample. For example, testing can involve capturing images of a biological fluid sample from an imaging sensor and determining one or more parameters of the biological fluid sample and/or components thereof. To do so, in an example, a sample (e.g., from an animal's body fluid) potentially containing an antibody of interest that is specific for an antigen, is contacted with the antigen attached to the particle and with the anti-antigen antibody conjugated to a detectable label. In some examples, the antibody of interest, present in the sample, competes with the antibody conjugated to a detectable label for binding with the antigen attached to the particles. The amount of the label associated with the particles can then be determined after separating unbound antibody and the label. The signal obtained is inversely related to the amount of antibody of interest present in the sample. In an alternative example embodiment of a competitive immunoassay, a sample (e.g., from an animal's body fluid), potentially containing an analyte, is contacted with the analyte conjugated to a detectable label and with an anti-analyte antibody attached to the particle. In examples, the antigen in the sample competes with analyte conjugated to the label for binding to the antibody attached the particle. The amount of the label associated with the particles can then be determined after separating unbound antigen and label. The signal obtained is inversely related to the amount of analyte present in the sample.

In a further aspect, antibodies, antigens, and other binding members (e.g., aptamers) may be attached to the particle or to the label directly via covalent binding with or without a linker or may be attached through a separate pair of binding members as is well known (e.g., biotin: streptavidin, digoxigenin: anti-digoxiginen). In addition, while the examples herein reflect the use of immunoassays, the particles and methods of the disclosure may be used in other receptor binding assays, including nucleic acid hybridization assays, that rely on immobilization of one or more assay components to a solid phase.

Generally, devices and systems for preparing a slide with a biological fluid sample are described herein. An example slide preparation device, according to devices and systems disclosed herein, includes a vertical mounting member with one or more components engaged therewith. In example embodiments, the one or more components may be engaged with the vertical mounting member via one or more fasteners (e.g., screws, bolts) and/or one or more moving mechanisms (e.g., guide rail, sliding track, ball bearings). In examples, if the vertical mounting member is engaged with one or more moving components (e.g., via a guide rail), then the vertical mounting member or a surface thereof may define or otherwise influence the direction and/or range of motion of the moving component. Other examples are possible.

In one example, the slide preparation device may include an upper coupling member engaged with the vertical mounting member. In some examples, the upper coupling member may include a depression member structurally configured to engage a syringe assembly plunger. In examples, the depression member may include a roller mechanism to interface with a surface of a depression structure (e.g., an angled surface) such that as the depression member interfaces with the depression structure the syringe assembly plunger is depressed in relation to the syringe assembly. In examples, the upper coupling member may interface with the syringe assembly plunger via one or more attachments configured to receive the head of the syringe assembly plunger. In some example embodiments, the upper coupling member may interface with the syringe assembly plunger via one or more high-friction surfaces (e.g., rubber) and/or adhesives. Other examples are possible.

In example embodiments, the slide preparation device may include a lower coupling member engaged with the vertical mounting member. In examples, the lower coupling member is engaged with the vertical mounting member via one or more fasteners (e.g., screws, bolts) and/or one or more moving mechanisms (e.g., rotating bearings). In some examples, the lower coupling member may be configured, structurally, to receive a sample syringe assembly. In example embodiments, the sample syringe assembly may include one or more components, including a needle in fluid communication with a reservoir containing a biological fluid sample and plunger to disperse the biological fluid sample via the needle as the plunger is depressed through a body. In examples, the lower coupling member may interface with the syringe assembly via one or more attachments configured to receive one or more portions of the syringe assembly, including the body. In some example embodiments, the lower coupling member may interface with the syringe assembly via one or more high-friction surfaces (e.g., rubber) and/or adhesives. In some embodiments, the lower coupling member may interface with the syringe assembly via one or more clamps and/or other fastening mechanism. In some examples, the biological fluid sample comprises one or more of the following: (i) blood; (ii) urine; (iii) saliva; (iv) semen; (v) secretion; (vi) excretion; (vii) fine needle aspirates; and (viii) body cavity fluids. Other examples are possible.

In some example embodiments, the lower coupling member holds the syringe assembly at a configurable angle with respect to a slide positioned on a slide holder of the slide preparation device. In some examples, the syringe assembly may be interfaced with the vertical mounting member such that the needle of the syringe assembly is approximately 45 degrees relative to the surface of the slide as the biological fluid sample is dispersed onto the surface of the slide. In example embodiments, the lower coupling member may be configures to accomplish one or more additional or alternative angles between the needle of the syringe assembly and the surface of the slide, including 10 degrees, 15 degrees, 20 degrees, 25 degrees, 30 degrees, 35 degrees, 40 degrees, 50 degrees, 55 degrees, 60 degrees, 65 degrees, 70 degrees, 75 degrees, 80 degrees, 85 degrees, and/or 90 degrees, among other possibilities.

In a further aspect, in examples, the example slide preparation device may also include a horizontal mounting member with one or more components engaged therewith. In example embodiments, the one or more components may be engaged with the horizontal mounting member via one or more fasteners (e.g., screws, bolts) and/or one or more moving mechanisms (e.g., guide rail, sliding track, ball bearings). In examples, if the horizontal mounting member is engaged with one or more moving components (e.g., via a guide rail), then the horizontal mounting member or a surface thereof may define or otherwise influence the direction and/or range of motion of the moving component. Other examples are possible.

In example embodiments, the slide preparation device may include a depression structure that is engaged with the vertical mounting member and/or the horizontal mounting member. In examples, the lower coupling member is engaged with the vertical mounting member and/or the horizontal mounting member via one or more fasteners (e.g., screws, bolts) and/or one or more moving mechanisms (e.g., guide rail, sliding track, ball bearings). In some examples, the depression structure may be configured, structurally, to receive one or more slides onto which a biological fluid sample may be disposed and/or dispensed. In some examples, these slides include a glass slide that is configured to receive a biological sample from the needle of the sample syringe assembly.

In example embodiments, the slide holder may hold the slide such that the sample syringe assembly dispenses, via a needle, the biological fluid sample as the depression structure is moved in a direction defined by the vertical mounting member and/or the horizontal mounting member. In a further aspect, in examples, the plunger of the syringe assembly may cause the biological fluid sample to disperse via the needle as the plunger is depressed through a body based on the depression structure moving in a direction defined by the vertical mounting member and/or the horizontal mounting member. In examples, the depression structure may interface with the depression member structurally configured to engage the syringe assembly plunger, including in examples where the depression member may include a roller mechanism that interfaces with a surface of a depression structure (e.g., an angled surface) such that as the depression member interfaces with the depression structure the syringe assembly plunger is depressed in relation to the syringe assembly. In some examples, one or more portions of the syringe assembly may be stationary in relation to the moving depression structure due to the lower coupling member remaining stationary in relation to the moving depression structure (e.g., because the lower coupling member is fastened to the vertical mounting member via one or more stationary bolts). In some examples, the lower coupling member may move in relation to the moving depression structure (e.g., because the lower coupling member is fastened to the vertical mounting member via a rotating bearings). Other examples are possible.

In some example embodiments, the surface of the depression structure that interfaces with the depression member may take one or more shapes, including: a flat shape, a semi-flat shape, a substantially flat shape, a curved shape, a semi-curved shape, a triangular shape, and/or a semi-rounded shape, among other possibilities. In a further aspect, one or more dimensions, orientations, and/or configurations of the depression structure surface may be configured to interact with and/or control one or more characteristics of the dispensing of the biological fluid sample. In examples embodiments, these dimensions and/or configurations of the depression structure surface may be configured to control and/or otherwise adjust the depression characteristics of the syringe assembly plunger through the syringe assembly body. In examples, this control and/or adjustment causes the dispensing characteristics of the biological fluid sample to change in line with the adjusted depressions characteristics, including one of the following: (i) flow rate of the biological fluid sample; (ii) angle of deposit of the biological fluid sample; and (iii) syringe assembly plunger depth. In examples, assuming a constant speed of movement for the depression structure in relation to the vertical mounting member and/or the horizontal mounting member, increasing the angle of incidence between the depression structure and the depression member will cause a faster flow rate of the biological fluid sample onto the slide. Conversely, in examples, decreasing the angle of incidence between the depression structure and the depression member will cause a slower flow rate of the biological fluid sample onto the slide. Other examples are possible.

In some examples, the depression structure may include an upper portion that engages with the vertical mounting member (e.g., via a guide rail) and a lower portion that engages with the horizontal mounting member (e.g., via a second, separate guide rail). In examples, the upper portion of the depression structure may comprise one or more components, including an adjustable engagement mechanism. In examples, this adjustable engagement mechanisms includes one or more of modular engagement members that include the surface of the depression structure that interfaces with the depression member. In examples, one or more of these modular engagement members may be configured to accomplish one or more specific dispersion events as the depression structure is moved in a direction defined by the vertical and/or horizontal mounting members (e.g., via different surface shapes, angles, etc. of each modular engagement member). In a further aspect, in example embodiments, these modular engagement members may be adjusted such that the height of incidence between the depression structure and the depression member can be adjusted (e.g., to adjust the plunger depth in the syringe assembly body from dispersion event to dispersion event). In examples, the adjustable engagement mechanism also includes one or more fasteners to attach, remove, and reattach the modular engagement member to the depression structure (e.g., via a hand fastener) and/or one or more moving mechanisms to adjust one or more characteristics of the modular engagement member in relation to the depression (e.g., via one or more guide rails). In examples, the lower portion of the depression structure may include one or more components, including a slide holder configured to hold one or more slides.

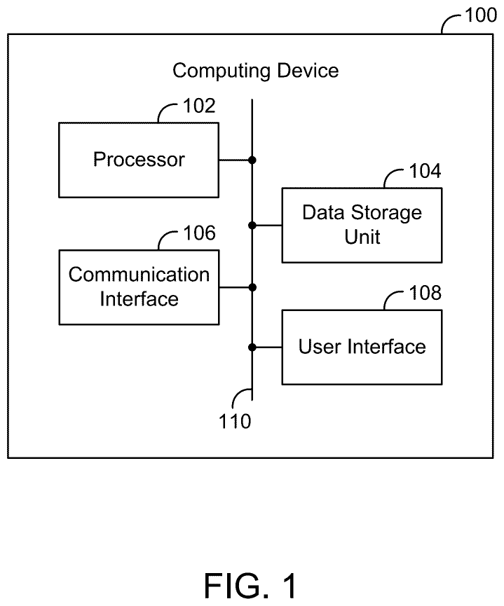

In some examples, the movement of the depression structure may be performed manually (e.g., by a user of the slide preparation device). In some examples, the movement of the depression structure may be performed by one or more motors, computers, and/or controllers (such as those described in connection with FIG. 1 below). Other examples are possible.

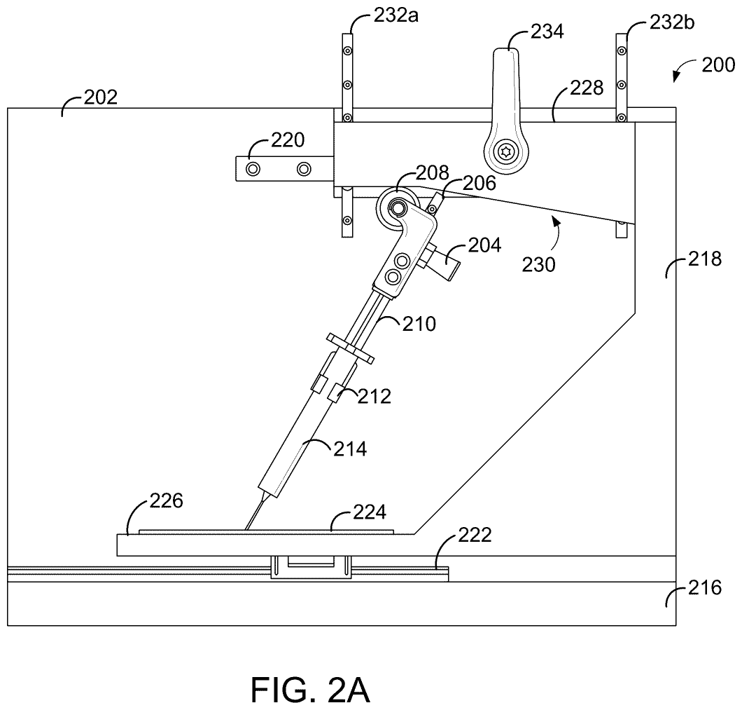

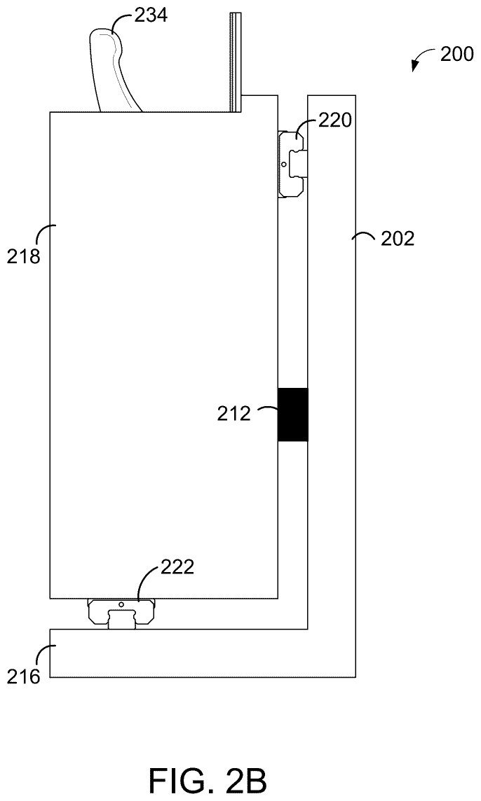

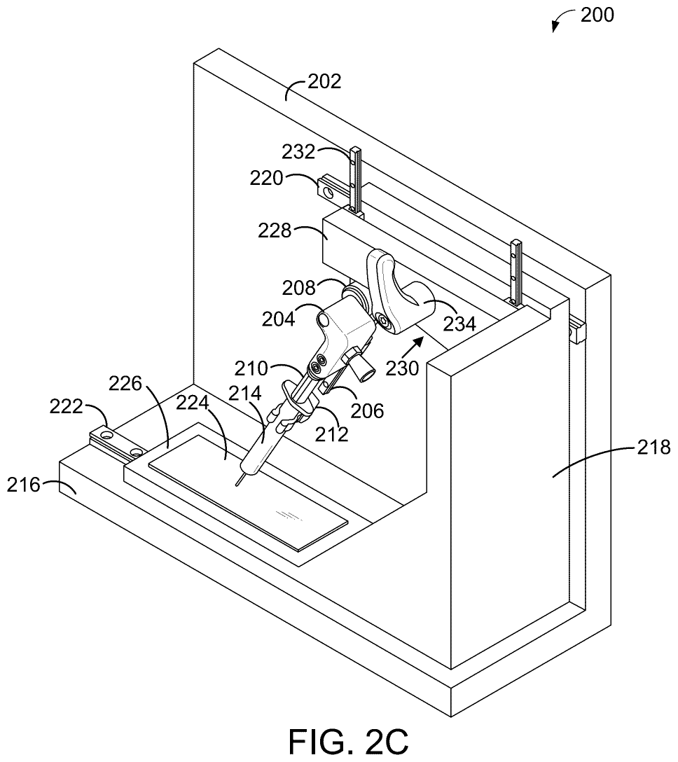

Referring now to the figures, FIG. 1 is a simplified block diagram of an example computing device 100 of a system (e.g., that can be utilized with devices and methods illustrated in FIGS. 2A-4, described in further detail below). Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor) and/or a special-purpose processor (e.g., a digital signal processor (DSP)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI-FI interface. In this disclosure, a connection can be a direct connection or an indirect connection, the latter being a connection that passes through and/or traverses one or more entities, such as such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 108 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Referring now to FIGS. 2A-2C which illustrate an example slide preparation device. An example slide preparation device includes a vertical mounting member, an upper coupling member, a depression member structurally configured to engage a syringe assembly plunger, a lower coupling member configured to receive a sample syringe assembly, a horizontal mounting member, and a depression structure comprising a slide holder, among other components.

Now referring to FIG. 2A, FIG. 2A illustrates an example slide preparation device 200. As illustrated in FIG. 2A, example slide preparation device 200 includes vertical mounting member 202, upper coupling member 204, first guide rail assembly 206, depression member 208, plunger 210, lower coupling member 212, syringe assembly 214, horizontal mounting member 216, depression structure 218, second guide rail assembly 220, third guide rail assembly 222, slide 224, slide holder 226, modular engagement member 228 (with a surface 230), fourth guide rail assembly 232a and 232b, and fastener 234. According to example embodiments, FIG. 2A represents the assembled view of example slide preparation device 200. Many example configurations are possible.

In examples, slide preparation device 200 and/or one or more components thereof, may be made of one or more materials, including: (i) metal alloys (including a stainless steel alloy); (ii) plastics; (iii) rubber; (iv) elemental metals; (v) ceramics; and (vi) metal composites, among other possibilities. Other examples are possible.

As shown in FIG. 2A, in example embodiments, the slide preparation device 200 includes an upper coupling member 204 engaged with the vertical mounting member 202 via first guide rail assembly 206. As shown in FIG. 2A, in example embodiments, the upper coupling member 204 also includes a depression member 208 that is structurally configured to engage a syringe assembly plunger 210 and interface with a surface 230 of modular engagement member 228 via include a roller mechanism of depression member 208. As shown in FIG. 2A, modular engagement member 228 is part of an upper portion of depression structure 218 such that as the roller mechanism of depression member 208 interfaces with surface 230 of modular engagement member 228, the syringe assembly plunger 210 is depressed in relation to the syringe assembly 214.

In example embodiments, the slide preparation device 200 may include a lower coupling member 212 engaged with the vertical mounting member 202. As illustrated in FIG. 2A, the lower coupling member is engaged with the vertical mounting member via a stationary fastener and is configured, structurally, to receive syringe assembly 214. As illustrated in FIG. 2A, in example embodiments, the syringe assembly includes a needle in fluid communication with a syringe assembly body of the syringe assembly (a reservoir), which may contain a biological fluid sample, such as blood. In a further aspect, syringe assembly 214 also includes plunger 210, which is used in FIG. 2A to disperse the biological fluid sample via the needle onto slide 224 as the plunger is depressed through a body. In examples, as illustrates in FIG. 2A, the lower coupling member 212 interfaces with the syringe assembly via a clamp and holds the syringe assembly at a specific configurable angle, approximately 60 degrees, with respect to slide 224, which is positioned on slide holder 226. Other angles and configurations are possible.

As shown in FIG. 2A, in example embodiments, the slide preparation device 200 also includes depression structure 218, which is engaged with the vertical mounting member 202 via second guide rail assembly 220 and the horizontal mounting member 216 via third guide rail assembly 222. As shown in FIG. 2A, in example embodiments, the depression structure 218 is also configured, structurally, to receive slide 224 onto which a biological fluid sample may be disposed and/or dispensed via the needle of syringe assembly 214. In example embodiments, the slide holder 226 may hold the slide 224 such that the sample syringe assembly dispenses, via a needle, the biological fluid sample as the depression structure 218 is moved in the direction defined by the vertical mounting member 202 and/or the horizontal mounting member 216, via second guide rail assembly 220 and third guide rail assembly 222, respectively. In FIG. 2A, the plunger 210 of the syringe assembly 214 causes the biological fluid sample to disperse via the needle of syringe assembly 214 as the plunger 210 is depressed through a body based on the depression structure 218 moving in a direction defined by the vertical mounting member 202 and the horizontal mounting member 216. In the context of FIG. 2A, this direction would be accomplished by the depression structure 218 moving right to left in relation to the vertical mounting member 202 and the horizontal mounting member 216, with the vertical mounting member 202, the horizontal mounting member 216, and the body and needle of the syringe assembly 214 remaining stationary as the depression structure moves right to left.

In FIG. 2A, in examples, the depression member 208 includes a roller mechanism that interfaces with surface 230 of modular engagement member 228, which forms an upper portion of depression structure 218. As shown in FIG. 2A, the first portion of the surface 230 of modular engagement member 228 is flat, which would not cause the plunger 210 to depress any further as the depression structure 218 is moved right to left. However, as shown in FIG. 2A, as the second portion of the surface 230 (e.g., the angled surface) of modular engagement member 228 is angled, the plunger 210 would depress further, in a substantially linear fashion, as the depression structure 218 is moved right to left. Furthermore, as illustrated in FIG. 2A, in some example embodiments, the surface 230 can take one or more different shapes, including: a flat shape, a semi-flat shape, a substantially flat shape, a curved shape, a semi-curved shape, a triangular shape, and/or a semi-rounded shape, among other possibilities.

In FIG. 2A, in examples, the upper portion of the depression structure 218 also comprises an adjustable engagement mechanism, which in the context of FIG. 2A includes modular engagement member 228 (with a surface 230), fourth guide rail assembly 232a and 232b, and fastener 234 (shown in FIG. 2A as a hand fastener). In examples, this adjustable engagement mechanisms the modular engagement member 228 may be configured to be removed and replaced with one or more additional modular engagement members of different sizes, shapes, configurations, etc., all of which may be accomplished via fourth guide rail assembly 232a/232b and fastener 234. In a further aspect, fourth guide rail assembly 232a/232b and fastener 234 may be used to adjust the height of incidence between the surface 230 of modular engagement member 228 and the depression member 208. In examples, this arrangement may be used to adjust the depth of the plunger 210 into the syringe assembly body from dispersion event to dispersion event. For example, after moving the dispersion structure right to left to cause a first dispersion event of the biological fluid onto the slide 224, the height of modular engagement member 228 may be lower to reduce the distance between the surface 230 of modular engagement member 228 and the depression member 208 for a second dispersion event (which may involve dispersing another portion of the biological fluid onto the slide 224). Other examples are possible.

Now referring to FIG. 2B, FIG. 2B illustrates the example slide preparation device 200 of FIG. 2A, from a side view angle. As illustrated in FIG. 2A, example slide preparation device 200 includes vertical mounting member 202, lower coupling member 212, horizontal mounting member 216, depression structure 218, second guide rail assembly 220, third guide rail assembly 222, and fastener 234. According to example embodiments, like FIG. 2A, FIG. 2B represents the assembled view of example slide preparation device 200, except from a side view perspective.

Now referring to FIG. 2C, FIG. 2C illustrates the example slide preparation device 200 of FIGS. 2A-2B, from an isometric view perspective. As illustrated in FIG. 2C, example slide preparation device 200 includes vertical mounting member 202, upper coupling member 204, first guide rail assembly 206, depression member 208, plunger 210, lower coupling member 212, syringe assembly 214, horizontal mounting member 216, depression structure 218, second guide rail assembly 220, third guide rail assembly 222, slide 224, slide holder 226, modular engagement member 228 (with a surface 230), fourth guide rail assembly 232a and 232b, and fastener 234. According to example embodiments, like FIGS. 2A-2B, FIG. 2C represents the assembled view of example slide preparation device 200, except from an isometric view perspective. Many example configurations are possible.

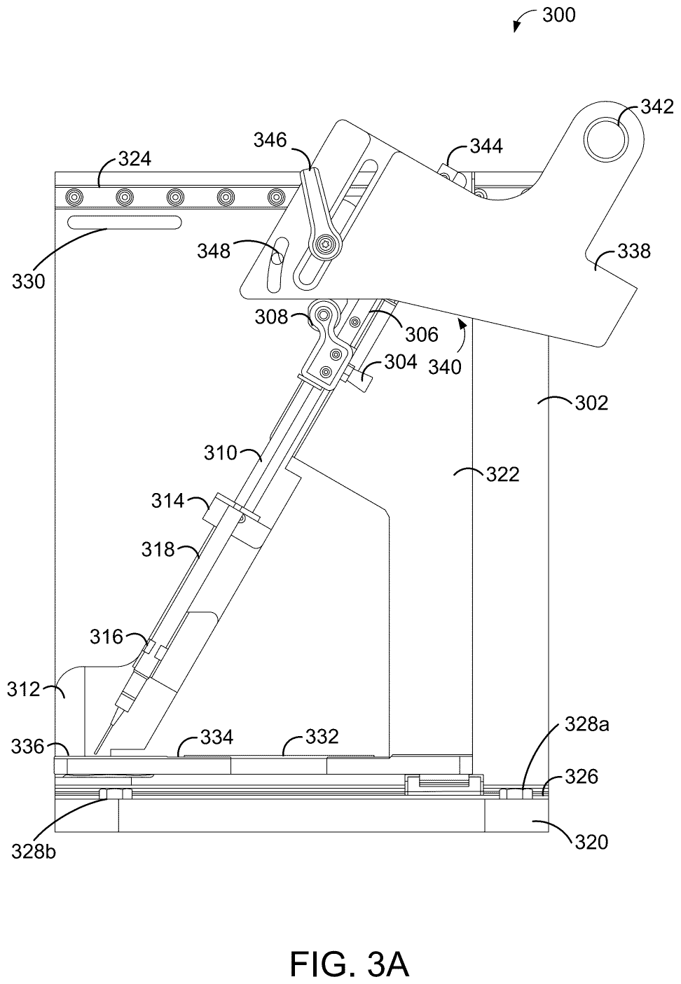

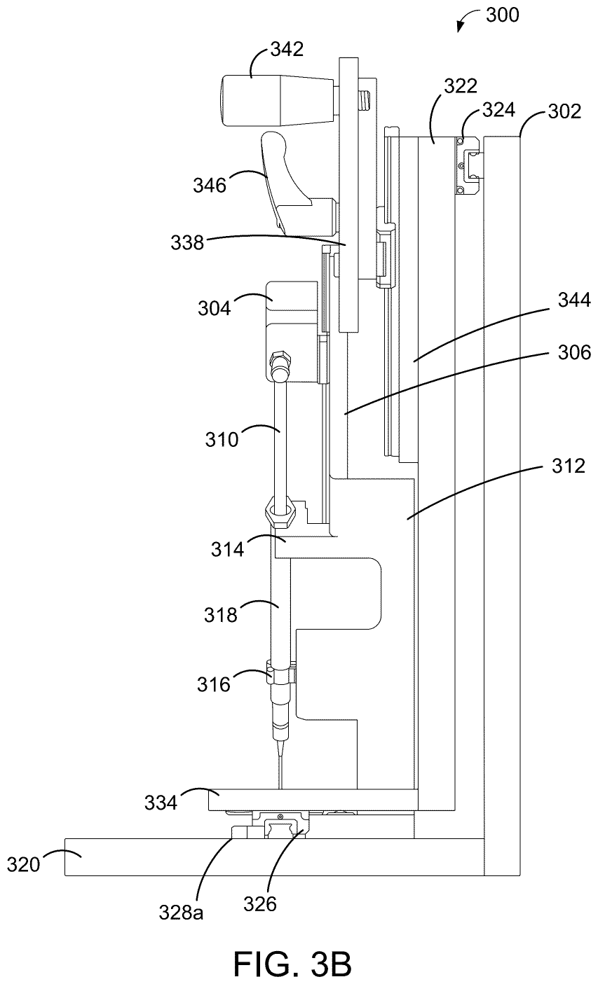

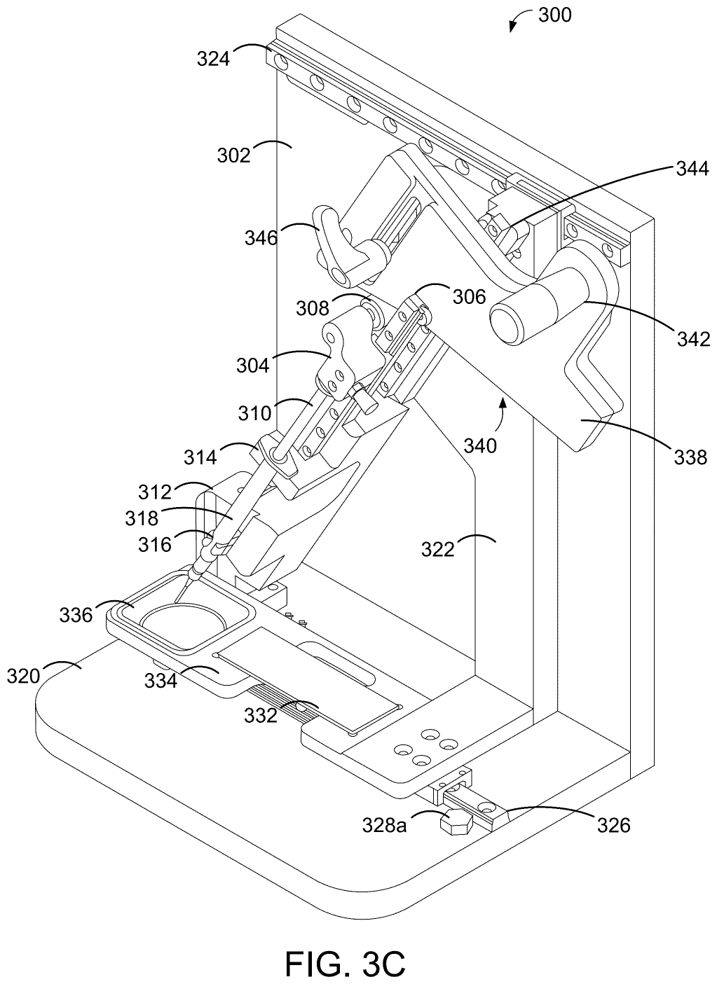

Now referring to FIG. 3A, FIG. 3A illustrates an example slide preparation device 300. As illustrated in FIG. 2A, example slide preparation device 200 includes vertical mounting member 302, upper coupling member 304, first guide rail assembly 306, depression member 308, plunger 310, lower coupling member 312, first lower coupling member mechanism 314, second lower coupling member mechanism 316, syringe assembly 318, horizontal mounting member 320, depression structure 322, second guide rail assembly 324, third guide rail assembly 326, security posts 328a and 328b, opening 330, slide 332, slide holder 334, bin 336, modular engagement member 338 (with a surface 340), handle 342, fourth guide rail assembly 344, fastener 346, and tilt adjustment 348. According to example embodiments, FIG. 3A represents the assembled view of example slide preparation device 300. Many example configurations are possible.

In examples, slide preparation device 300 and/or one or more components thereof, may be made of one or more materials, including: (i) metal alloys (including a stainless steel alloy); (ii) plastics; (iii) rubber; (iv) elemental metals; (v) ceramics; and (vi) metal composites, among other possibilities. Other examples are possible.

As shown in FIG. 3A, in example embodiments, the slide preparation device 300 includes an upper coupling member 304 engaged with the vertical mounting member 302 via first guide rail assembly 306. As shown in FIG. 3A, in example embodiments, the upper coupling member 304 also includes a depression member 308 that is structurally configured to engage a syringe assembly plunger 310 and interface with a surface 340 of modular engagement member 338 via include a roller mechanism of depression member 308. As shown in FIG. 3A, modular engagement member 338 is part of an upper portion of depression structure 322 such that as the roller mechanism of depression member 308 interfaces with surface 340 of modular engagement member 338, the syringe assembly plunger 310 is depressed in relation to the syringe assembly 318.

In example embodiments, the slide preparation device 300 may include a lower coupling member 312 engaged with the vertical mounting member 302. As illustrated in FIG. 3A, the lower coupling member 312 comprises a body with one or more portions engaged with the vertical mounting member via one or more stationary fasteners. In FIG. 3A, the lower coupling member is configured, structurally, to receive syringe assembly 318 via first lower coupling member mechanism 314 and second lower coupling member mechanism 316. As shown in FIG. 3A, the first lower coupling member mechanism 314 is configured to receive and stabilize the head of the syringe body, and keep the body from moving when the syringe plunger 310 is depressed into the syringe body. As also shown in FIG. 3A, in examples, the lower coupling member 312 interfaces with the syringe assembly via a clamp on second lower coupling member mechanism 316 and holds the syringe assembly at a specific configurable angle, approximately 60 degrees, with respect to slide 332. Other angles and configurations are possible.

As illustrated in FIG. 3A, like FIG. 2A, in example embodiments, the syringe assembly includes a needle in fluid communication with a syringe assembly body of the syringe assembly (a reservoir), which may contain a biological fluid sample, such as blood. In a further aspect, syringe assembly 318 also includes plunger 310, which is used in FIG. 3A to disperse the biological fluid sample via the needle onto slide 332 as the plunger is depressed through a body. As also shown in FIG. 3A, slide preparation device 300 includes a bin 336, which may be configured to receive any over dispersed biological fluid sample that is dispersed after the sample has been dispersed on the slide 332. In examples, bin 336 may be configured to provide a reservoir from which and/or to which a liquid may be placed for the syringe assembly 318.

As also shown in FIG. 3A, in example embodiments, the slide preparation device 300 also includes depression structure 322, which is engaged with the vertical mounting member 302 via second guide rail assembly 324 and the horizontal mounting member 320 via third guide rail assembly 326. As shown in FIG. 3A, in example embodiments, the depression structure 322 is also configured, structurally, to receive slide 332 onto which a biological fluid sample may be disposed and/or dispensed via the needle of syringe assembly 318. In example embodiments, the slide holder 334 may hold the slide 332 such that the sample syringe assembly dispenses, via a needle, the biological fluid sample as the depression structure 322 is moved in the direction defined by the vertical mounting member 302 and/or the horizontal mounting member 320, via second guide rail assembly 324 and third guide rail assembly 326, respectively. In a further aspect, as shown in FIG. 3A, the length of the path that is taken as the depression structure 322 during the dispensing event may be defined by one or more components of slide preparation device 300, including security posts 328a and 328b. In example embodiments, as shown in FIG. 3A, these security posts 328a and 328b may be implemented as one or more bolts (or other fasteners) that provide a path length and/or boundaries along which the depression structure 322 may travel. In examples, security posts 328a and 328b may provide additional and/or alternative functionality to the slide preparation device 300, including to secure and/or otherwise stabilize slide preparation device 300 to secure to a surface (e.g., a table top) and/or provide one or more adjustment functionalities (e.g., leveling) to slide preparation device 300. Furthermore, in examples, slide preparation device 300 may include additional configurations, including opening 330, through which one or more additional security posts may be integrated (e.g., to define a path length along the vertical mounting member 302 for which depression structure 322 may travel along second guide rail assembly 324). Other examples are possible.

Similar to FIG. 2A, in FIG. 3A, the plunger 310 of the syringe assembly 318 causes the biological fluid sample to disperse via the needle of syringe assembly 318 as the plunger 310 is depressed through a body based on the depression structure 322 moving in a direction defined by the vertical mounting member 302 and the horizontal mounting member 320 and along a path length defined by security posts 328a and 328b. In the context of FIG. 3A, this direction would be accomplished by the depression structure 322 moving right to left in relation to the vertical mounting member 302 and the horizontal mounting member 320, with the vertical mounting member 302, the horizontal mounting member 320, and the body and needle of the syringe assembly 318 remaining stationary as the depression structure moves right to left depressing the plunger 310 of the syringe assembly 318.

In FIG. 3A, in examples, the depression member 308 includes a roller mechanism that interfaces with surface 340 of modular engagement member 338, which forms an upper portion of depression structure 322. As shown in FIG. 3A, the first portion of the surface 340 of modular engagement member 338 is flat, which would not cause the plunger 310 to depress any further as the depression structure 322 is moved right to left. However, as shown in FIG. 3A, as the second portion of the surface 340 (e.g., the angled surface) of modular engagement member 338 is angled, the plunger 310 would depress further, in a substantially linear fashion, as the depression structure 322 is moved right to left. Furthermore, as illustrated in FIG. 3A, in some example embodiments, the surface 340 can take one or more different shapes, including: a flat shape, a semi-flat shape, a substantially flat shape, a curved shape, a semi-curved shape, a triangular shape, and/or a semi-rounded shape, among other possibilities.

In FIG. 3A, in examples, the upper portion of the depression structure 322 also comprises an adjustable engagement mechanism, which in the context of FIG. 3A includes modular engagement member 338 (with a surface 340), fourth guide rail assembly 344, fastener 346 (shown in FIG. 3A as a hand fastener), and tilt adjustment 348. In examples, this adjustable engagement mechanisms the modular engagement member 338 may be configured to be removed and replaced with one or more additional modular engagement members of different sizes, shapes, configurations, etc., all of which may be accomplished via fourth guide rail assembly 344 and fastener 346. In a further aspect, fourth guide rail assembly 344, fastener 346, and/or tilt adjustment 348 may be used to adjust the height and/or angle of incidence between the surface 340 of modular engagement member 338 and the depression member 308. In examples, this arrangement may be used to adjust the depth of the plunger 310 into the syringe assembly body from dispersion event to dispersion event. For example, after moving the dispersion structure right to left to cause a first dispersion event of the biological fluid onto the slide 332, the height of modular engagement member 338 may be lower to reduce the distance between the surface 340 of modular engagement member 338 and the depression member 308 for a second dispersion event (which may involve dispersing another portion of the biological fluid onto the slide 332). In other examples, the angle of incidence between the surface 340 of modular engagement member 338 and depression member 308 may be adjusted (e.g., via fastener 346 and/or tilt adjustment 348) to increase or decrease one or more characteristics of the dispersion event, including the rate of dispersion over a distanced traveled as the depression structure 322 is moved right to left. Other examples are possible.

Now referring to FIG. 3B, FIG. 3B illustrates the example slide preparation device 300 of FIG. 3A, from a side view angle. As illustrated in FIG. 3A, example slide preparation device 300 includes vertical mounting member 302, upper coupling member 304, first guide rail assembly 306, plunger 310, lower coupling member 312, first lower coupling member mechanism 314, second lower coupling member mechanism 316, syringe assembly 318, horizontal mounting member 320, depression structure 322, second guide rail assembly 324, third guide rail assembly 326, security posts 328a, slide holder 334, modular engagement member 338, handle 342, fourth guide rail assembly 344, and fastener 346. According to example embodiments, like FIG. 3A, FIG. 3B represents the assembled view of example slide preparation device 300, except from a side view perspective.

Now referring to FIG. 3C, FIG. 3C illustrates the example slide preparation device 300 of FIGS. 3A-3B, from an isometric view perspective. As illustrated in FIG. 3C, example slide preparation device 300 includes vertical mounting member 302, upper coupling member 304, first guide rail assembly 306, depression member 308, plunger 310, lower coupling member 312, first lower coupling member mechanism 314, second lower coupling member mechanism 316, syringe assembly 318, horizontal mounting member 320, depression structure 322, second guide rail assembly 324, third guide rail assembly 326, security posts 328a and 328b, slide 332, slide holder 334, bin 336, modular engagement member 338 (with a surface 340), handle 342, fourth guide rail assembly 344, and fastener 346. According to example embodiments, like FIGS. 3A-3B, FIG. 3C represents the assembled view of example slide preparation device 300, except from an isometric view perspective. Many example configurations are possible.

### EXAMPLE METHODS AND ASPECTS

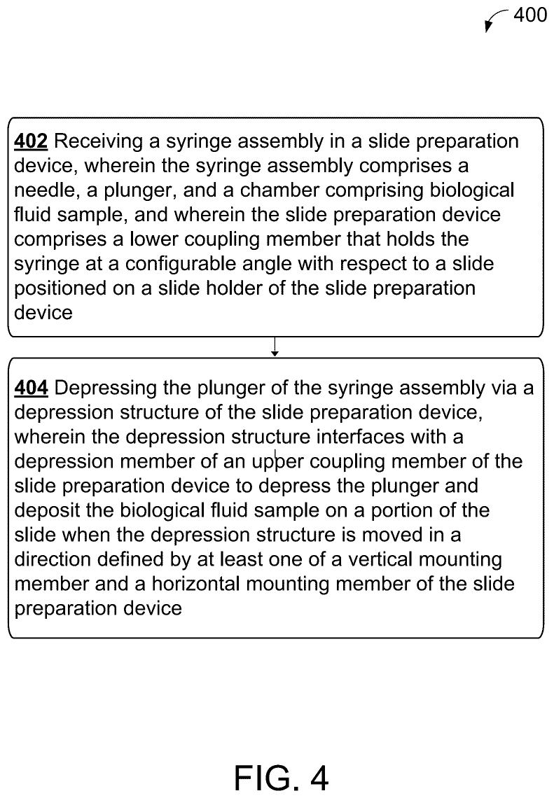

Now referring to FIG. 4, an example method for preparing a slide is disclosed. Method 400 shown in FIG. 4 presents an example of a method for using an example slide preparation device that could be used with the example slide preparation device shown in FIGS. 2A-2C and 3A-3C, for example. Further, devices or systems may be used or configured to perform logical functions presented in FIG. 4. In other examples, components of the devices and/or systems may be arranged to be adapted to, capable of, or suited for performing the functions, such as when operated in a specific manner. Method 400 may include one or more operations, functions, or actions as illustrated by one or more of blocks 402-404. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 402, method 400 involves receiving a syringe assembly in a slide preparation device, wherein the syringe assembly comprises a needle, a plunger, and a chamber comprising biological fluid sample, and wherein the slide preparation device comprises a lower coupling member that holds the syringe assembly at a configurable angle with respect to the slide positioned on a slide holder of the slide preparation device. In some example embodiments, the biological fluid sample comprises one or more of the following: (i) blood; (ii) urine; (iii) saliva; (iv) semen; (v) secretion; (vi) excretion; (vii) fine needle aspirates; and (viii) body cavity fluids.

At block 404, method 400 involves depressing the plunger of the syringe assembly via a depression structure of the slide preparation device, wherein the depression structure interfaces with a depression member of an upper coupling member of the slide preparation device to depress the plunger and deposit the biological fluid sample on a portion of the slide when the depression structure is moved in a direction defined by at least one of a vertical mounting member and a horizontal mounting member of the slide preparation device. In some example embodiments, the depression member comprises a roller mechanism to interface with a surface of the depression structure as the depression structure interfaces with the depression member to depress the plunger. In some examples, the depression structure comprises an upper portion and lower portion, and wherein the upper portion engages the vertical mounting member and the lower portion engages the horizontal mounting member. In some example embodiments, the lower portion comprises the slide holder.

In some example embodiments, the upper portion comprises an adjustable engagement mechanism, and method 400 further comprises adjusting a depression characteristic of the syringe assembly as the depression structure interfaces with the depression member to depress the plunger. In some examples, the depression characteristic comprises one or more of the following: (i) flow rate of the biological fluid sample; (ii) angle of deposit of the biological fluid sample; and (iii) syringe assembly plunger depth.

In some example embodiments, the slide preparation device of method 400 further involves a motor coupled to the depression structure.

In one aspect, in example embodiments, a slide preparation device is disclosed. In example embodiments, the slide preparation device includes: (i) a vertical mounting member; (ii) an upper coupling member engaged with the vertical mounting member, wherein the upper coupling member comprises a depression member structurally configured to engage a syringe assembly plunger; (iii) a lower coupling member engaged with the vertical mounting member, wherein the lower coupling member is structurally configured to receive a sample syringe assembly comprising a biological fluid sample and the syringe assembly plunger; (iv) a horizontal mounting member, wherein the horizontal mounting member interfaces with the vertical mounting member; and (v) a depression structure engaged with the vertical mounting member and the horizontal mounting member, wherein the depression structure comprises a slide holder, and wherein the depression structure interfaces with the depression member to depress the syringe assembly plunger and deposits the biological fluid sample on a portion of a slide in the slide holder when the depression structure is moved in a direction defined by at least one of the vertical mounting member and the horizontal mounting member.

In one aspect, in examples, the slide preparation device further comprises a motor coupled to the depression structure. In another aspect, in examples, the lower coupling member is stationary with respect to the slide holder when the depression structure is moved in the direction defined by at least one of the vertical mounting member and the horizontal mounting member. In another aspect, in examples, the lower coupling member is movable with respect to the slide holder when the depression structure is moved in the direction defined by at least one of the vertical mounting member and the horizontal mounting member. In another aspect, in examples, the depression structure comprises an upper portion and lower portion, and wherein the upper portion engages the vertical mounting member and lower portion engages the horizontal mounting member. In another aspect, in examples, the upper portion comprises an adjustable engagement mechanism, wherein the adjustable engagement mechanism adjusts a depression characteristic of the syringe assembly as the depression structure interfaces with the depression member to depress the syringe assembly plunger. In another aspect, in examples, the depression characteristic comprises one or more of: (i) flow rate of the biological fluid sample; (ii) angle of deposit of the biological fluid sample; and (iii) syringe assembly plunger depth.

In another aspect, in examples, the lower portion comprises the slide holder.

In another aspect, in examples, the depression member comprises a roller mechanism to interface with a surface of the depression structure as the depression structure interfaces with the depression member to depress the syringe assembly plunger.

In another aspect, in examples, the biological fluid sample comprises one or more of: (i) blood; (ii) urine; (iii) saliva; (iv) semen; (v) secretion; (vi) excretion; (vii) fine needle aspirates; and (viii) body cavity fluids. The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

We claim:

1. A slide preparation device comprising:
a vertical mounting member;
an upper coupling member engaged with the vertical mounting member, wherein the upper coupling member comprises a depression member structurally configured to engage a syringe assembly plunger;
a lower coupling member engaged with the vertical mounting member, wherein the lower coupling member is structurally configured to receive a sample syringe assembly comprising a biological fluid sample and the syringe assembly plunger;
a horizontal mounting member, wherein the horizontal mounting member interfaces with the vertical mounting member; and
a depression structure engaged with the vertical mounting member and the horizontal mounting member, wherein the depression structure comprises a slide holder, and wherein the depression structure interfaces with the depression member to depress the syringe assembly plunger and deposit the biological fluid sample on a portion of a slide in the slide holder when the depression structure is moved in a direction defined by at least one of the vertical mounting member and the horizontal mounting member.

2. The slide preparation device of claim 1, further comprising a motor coupled to the depression structure.

3. The slide preparation device of claim 1, wherein the lower coupling member is stationary with respect to the slide holder when the depression structure is moved in the direction defined by at least one of the vertical mounting member and the horizontal mounting member.

4. The slide preparation device of claim 1, wherein the lower coupling member is movable with respect to the slide holder when the depression structure is moved in the direction defined by at least one of the vertical mounting member and the horizontal mounting member.

5. The slide preparation device of claim 1, wherein the depression structure comprises an upper portion and lower portion, and wherein the upper portion engages the vertical mounting member and lower portion engages the horizontal mounting member.

6. The slide preparation device of claim 5, wherein the upper portion comprises an adjustable engagement mechanism, wherein the adjustable engagement mechanism adjusts a depression characteristic of the syringe assembly as the depression structure interfaces with the depression member to depress the syringe assembly plunger.

7. The slide preparation device of claim 6, wherein the depression characteristic comprises one or more of: (i) flow rate of the biological fluid sample; (ii) angle of deposit of the biological fluid sample; and (iii) syringe assembly plunger depth.

8. The slide preparation device of claim 5, wherein the lower portion comprises the slide holder.

9. The slide preparation device of claim 1, wherein the depression member comprises a roller mechanism to interface with a surface of the depression structure as the depression structure interfaces with the depression member to depress the syringe assembly plunger.

10. The slide preparation device of claim 1, wherein the biological fluid sample comprises one or more of: (i) blood; (ii) urine; (iii) saliva; (iv) semen; (v) secretion; (vi) excretion; (vii) fine needle aspirates; and (viii) body cavity fluids.

11. A method for preparing a slide, the method comprising:
receiving a syringe assembly in a slide preparation device, wherein the syringe assembly comprises a needle, a plunger, and a chamber comprising biological fluid sample, and wherein the slide preparation device comprises a lower coupling member that holds the syringe assembly at a configurable angle with respect to the slide positioned on a slide holder of the slide preparation device; and
depressing the plunger of the syringe assembly via a depression structure of the slide preparation device, wherein the depression structure interfaces with a depression member of an upper coupling member of the slide preparation device to depress the plunger and deposit the biological fluid sample on a portion of the slide when the depression structure is moved in a direction defined by at least one of a vertical mounting member and a horizontal mounting member of the slide preparation device.

12. The method of claim 11, wherein the slide preparation device further comprises a motor coupled to the depression structure.

13. The method of claim 11, wherein the depression structure comprises an upper portion and lower portion, and wherein the upper portion engages the vertical mounting member and the lower portion engages the horizontal mounting member.

14. The method of claim 13, wherein the upper portion comprises an adjustable engagement mechanism, wherein the method further comprises adjusting a depression characteristic of the syringe assembly as the depression structure interfaces with the depression member to depress the plunger.

15. The method of claim 14, wherein the depression characteristic comprises one or more of: (i) flow rate of the biological fluid sample; (ii) angle of deposit of the biological fluid sample; and (iii) syringe assembly plunger depth.

16. The method of claim 13, wherein the lower portion comprises the slide holder.

17. The method of claim 11, wherein the depression member comprises a roller mechanism to interface with a surface of the depression structure as the depression structure interfaces with the depression member to depress the plunger.

18. The method of claim 11, wherein the biological fluid sample comprises one or more of: (i) blood; (ii) urine; (iii) saliva; (iv) semen; (v) secretion; (vi) excretion; (vii) fine needle aspirates; and (viii) body cavity fluids.

19. A non-transitory computer-readable medium comprising instructions that, when executed, cause one or more processors to perform a set of operations comprising:
receiving a syringe assembly in a slide preparation device, wherein the syringe assembly comprises a needle, a plunger, and a chamber comprising biological fluid sample, and wherein the slide preparation device comprises a lower coupling member that holds the syringe assembly at a configurable angle with respect to a slide positioned on a slide holder of the slide preparation device; and
depressing the plunger of the syringe assembly via a depression structure of the slide preparation device, wherein the depression structure interfaces with a depression member of an upper coupling member of the slide preparation device to depress the plunger and deposit the biological fluid sample on a portion of a slide in the slide holder by moving the depression structure in a direction defined by at least one of a vertical mounting member and a horizontal mounting member of the slide preparation device.

20. The non-transitory computer-readable medium of claim 19, wherein moving the depression structure in a direction defined by at least one of a vertical mounting member and a horizontal mounting member of the slide preparation device comprises moving the depression structure via a motor coupled to the depression structure.
